(19) United States
(12) Patent Application Publication
(10) Pub. No.: US 2008/0167994 A1
(43) Pub. Date: Jul. 10, 2008

(54) Digital Inheritance

(75) Inventors: Hong Li, Eindhoven (NL); Milan Petkovic, Eindhoven (NL); Eric Wilhelmus Josephus Moors, Eindhoven (NL); Albert Maria Arnold Rijckaert, Eindhoven (NL); Roland Peter Jan Mathijs Manders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/996,369

(22) PCT Filed: Jul. 7, 2006
(86) PCT No.: PCT/IB2006/052297

§ 371 Date: Jan. 22, 2008

(30) Foreign Application Priority Data
Jul. 22, 2005 (EP) 05106755.1

(51) Int. Cl. G06Q 10/00; H04L 9/14

(52) U.S. Cl. 705/52; 705/1

(57) ABSTRACT

The present invention relates to a method and a device of enabling inheritance of a digital content item. There is provided a method and a device by which inheritance of a digital content item is enabled by means of acquiring an inheritance license for an encrypted digital content item. The inheritance license specifies operations that are allowed to be performed on the content item after the death of its proprietor. Further, a death certificate of the proprietor of the encrypted content item is accessed, wherein authorization is given to perform at least a subset of the operations specified in the inheritance license on the encrypted content item.

The present invention relates to a method and a device of enabling inheritance of a digital content item.

Recent developments in digital technologies, along with increasingly interconnected high-speed networks and decreasing prices for high-performance digital devices, have established digital content distribution as one of the most rapidly emerging trading activities and have created new methods for consumers to access, manage, distribute and pay for digital content. As a consequence of this trend and the success of one of the first online music shop—Apple's iTunes, a number of shops have been opened and both consumers and content providers have clearly shown high interest in electronic distribution of audio/video content.

On the other hand, the production of digital information has turned out to be low-priced and open to everyone. Nowadays, people create digital photos and home movies to an ever increasing extent. Furthermore, the advances in digital storage technology, which doubles storage capacity every year, make digitization, compression, archiving and streaming of image and video data popular and inexpensive. Consequently, people in general have to manage a huge amount of digital data including commercial as well as personal content.

An important aspect in dealing with digital content is how to regulate inheritance of digital property. A straightforward approach would be to adhere to a traditional method of creating a will and treat the digital content the same way other material goods (for example real estate) are treated. For example, a user creates a will in a traditional way and deposits the content with a trusted third party. However, this is a rather inefficient and static approach. Instead of choosing a trusted third party, e.g. a notary or a lawyer, to guarantee the execution of the will after the death of the user, a person may rely on his compliant device and/or other persons to take the role of the notary, e.g. family members. In this way, the process of creating a last will is easy, and the will is further easily maintainable and modifiable by the user.

Further, some content can be treated as confidential and therefore can be stored protected (encrypted) or used within a DRM system (e.g. commercial content or protected personal content), which makes it difficult to use a traditional method for inheritance. For commercial content, although the user is not the real owner of the commercial content, it might be possible in different business scenarios for him to see to it that his copy of the content is inherited by his successor. This actually means that his license (rights with respect to content usage) has to be bound to the inheritor. For example, if a person owns a piece of protected content within a person-based DRM system, the encrypted raw data is useless for the inheritor unless the (ownership) license is transferred from the original owner to him. In a DRM system which uses tokens for user authentication, a user can give to his successor the token which authorizes the successor to inherit all the content of the user (which is obviously unpractical). Further, a DRM system can use biometrics for user authentication, which will make a traditional inheritance method obsolete.

Another aspect to be considered is that digital content items may consist of medical or financial records, which may be highly confidential and therefore protected, for example by means of encryption or access control mechanisms. An owner of such content items will most likely want to be certain that his integrity is really protected after his death, so that no one else could decrypt the content.

US patent application having publication no. 20020019744 discloses a last will and testament service method is provided which enables people to draw up their wills before their death, and which wills are transferred after the death of a testator/testatrix. Will information and authentication information are produced by a testator terminal. The will information is registered on a last will and testament service terminal. Updating information and authentication information are transmitted by the testator terminal. The will information is updated by the last will and testament service terminal. A notice of death of the testator/testatrix is accepted by a public office terminal and is registered as “dead person information” and the dead person information is transmitted. When the dead person information is received by the last will and testament service terminal and, after the death of the testator is confirmed, the will information is transmitted. The will information is received by an heir terminal.

A problem with 20020019744 is that the method and system disclosed therein are not capable of handling encrypted digital wills and associated content items, e.g. encrypted private digital content and commercial content. In other words, when the testator is dead, his personal identity (e.g. a biometric identity) cannot be used by any individual. Consequently, no one can handle his personal encrypted content items.

The above stated problem is solved by embodiments of the present invention as defined by the following description and the attached claims.

To this end, there is provided a method and a device by which inheritance of a digital content item is enabled by means of acquiring an inheritance license for an encrypted digital content item. The inheritance license specifies operations that are allowed to be performed on the content item after the death of its proprietor. Further, a death certificate of the proprietor of the encrypted content item is accessed, wherein authorization is given to perform at least a subset of the operations specified in the inheritance license on the encrypted content item.

This has the advantage that a testator may specify operations that a party, e.g. a compliant device, a trusted third party or an individual, in possession of the inheritance license and the death certificate is allowed to perform on the encrypted content item. In the following, for reasons of simplicity, it is assumed that the party is a trusted third party (TTP). An operation that may be specified in the license is for instance the operation of deleting the content item to which the license is associated. As an effect, sensitive content items such as medical or financial records will be deleted after the death of the testator.

Possibly, the inheritance license is further arranged to comprise a content item decryption key. If a testator wishes to publish a content item after his death, he has to provide the decryption key such that the party in possession of the inheritance license is able to provide a clear text copy of the content item and thus make it public. Note that even though the possible content decryption key is deleted (or inaccessible in case keys based on biometrics is employed), someone who has access to the encrypted content item could be able to decrypt it by using brute force attack. It is therefore preferred, in case deletion is required, to make sure that the encrypted content item is also deleted, and not just the decryption key.

Advantageously, with the above described approach, dynamic creation and automatic execution of a will or testament is enabled. An owner of a content item is thus allowed in an easy and on-the-fly manner to specify inheritors of the content item. Further, the testament may be amended with regular intervals.

In an embodiment of the present invention, the inheritance license is arranged to provide an identity of an intended inheritor of the encrypted content item. Further, the operations that are allowed to be performed on the content item after the death of its proprietor may comprise the operation of establishing transfer of ownership to the intended inheritor that is identified in the license. In order for a claimant to the content item to obtain access to it, the device on which the encrypted content item is stored checks whether a matching criteria is satisfied for an identity of the claimant to the encrypted content and the identity provided by the inheritance license. In case the matching criteria is considered to be satisfied, i.e. the identity of the claimant matches the identity of the inheritance license, a content item decryption key is distributed to the claimant. Hence, the claimant may employ the key to decrypt the encrypted content item and access the resulting clear text copy of the content item.

The identity of an intended inheritor of the encrypted content item may be provided in different ways.

For instance, the identity may be provided by means of including a public key of the intended inheritor in the inheritance license, and the matching criteria is considered to be satisfied if a public key of the claimant is identical to the public key included in the license. Possibly, the content item decryption key comprised in the inheritance license may be encrypted with the public key of the intended inheritor before it is distributed.

In another example, the inheritance license is encrypted with a public key of the intended inheritor, wherein the identity is provided by means of the actual encryption of the inheritance license, and the matching criteria is considered to be satisfied if a successful decryption of the inheritance license is made with a private key that corresponds to the public key of the claimant. Hence, if the claimant has access to a private key that corresponds to the public key comprised in the license, the claimant is considered to be authorized to perform, on the content item, the operations contained in the inheritance license.

The present invention defined by means of exemplifying embodiments allows for completing inheritance transactions of private (encrypted) content in a secure and easy way. When the last will in the form of an inheritance license is posthumously opened, the intended inheritor(s) will receive licenses and/or rights for transferring ownership, and appliances in the form of compliant devices and/or trusted third parties (TTPs) will securely complete the transactions. Further, it is possible to provide the inheritance license with non-repudiated evidence, if required by the law or the testator. The testator has the option to choose a trusted executor, e.g. a family members instead of an embowered attorney in the form of e.g. a lawyer.

In another embodiment of the present invention, the operations that are allowed to be performed on the content item after the death of its proprietor, which operations are defined in the inheritance license, are defined by which access rights an intended inheritor has to the encrypted content item. For instance, the access rights may define operations such as “play”, “copy”, “distribute”, “play for 48 hours”, etc.

In a further embodiment of the present invention, an ownership license is issued to the claimant for the content item in case the matching criteria is satisfied, which ownership license specifies the claimant as a new proprietor of the encrypted content item. Possibly, a timestamp representing time of issuing is included in the ownership license.

A detailed description of preferred embodiments of the present invention will be given in the following with reference made to the accompanying drawings, in which:

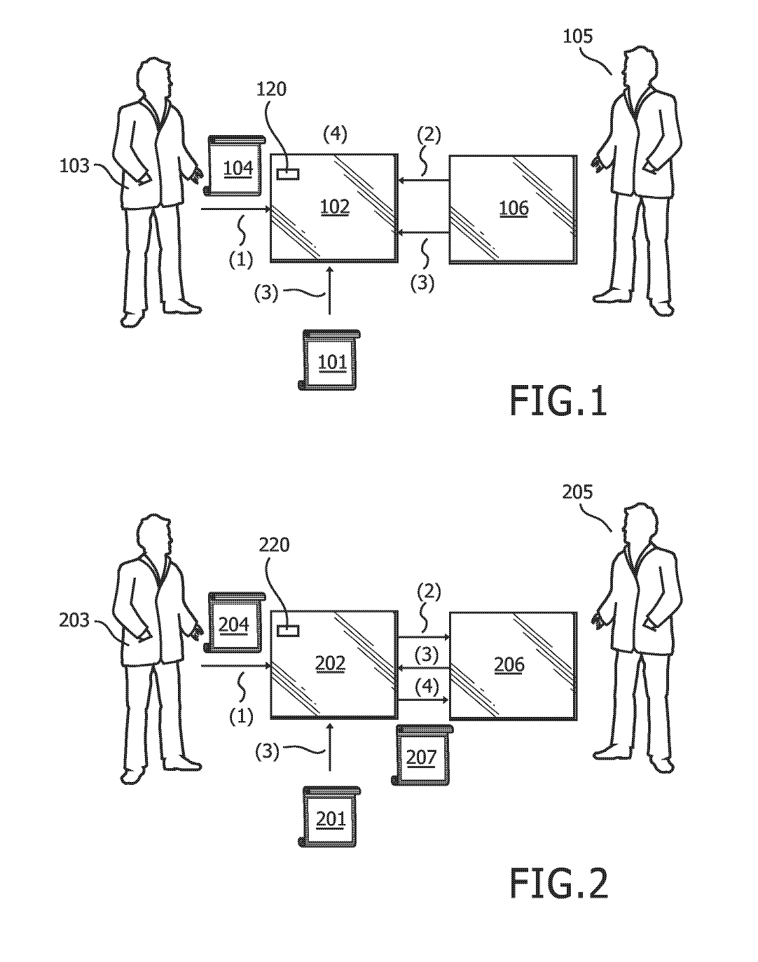

FIG. 1 shows an embodiment of the present invention, in which a user triggers a process of deleting or publishing a personal encrypted content item posthumously;

FIG. 2 shows another embodiment of the present invention, in which inheritance of an encrypted content item is enabled by employing an inheritance license and a death certificate of the deceased owner of the content item;

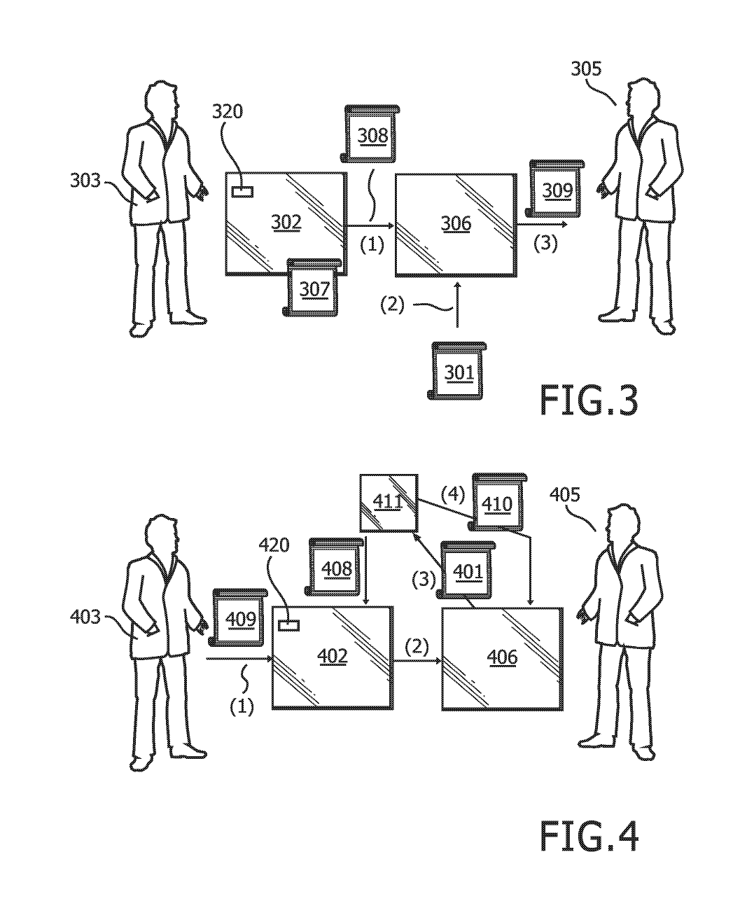

FIG. 3 illustrates a usage license employed in the process of inheriting an encrypted content item;

FIG. 4 shows yet another embodiment of the present invention shown in, wherein an additional license attached to the original inheritance license is used; and

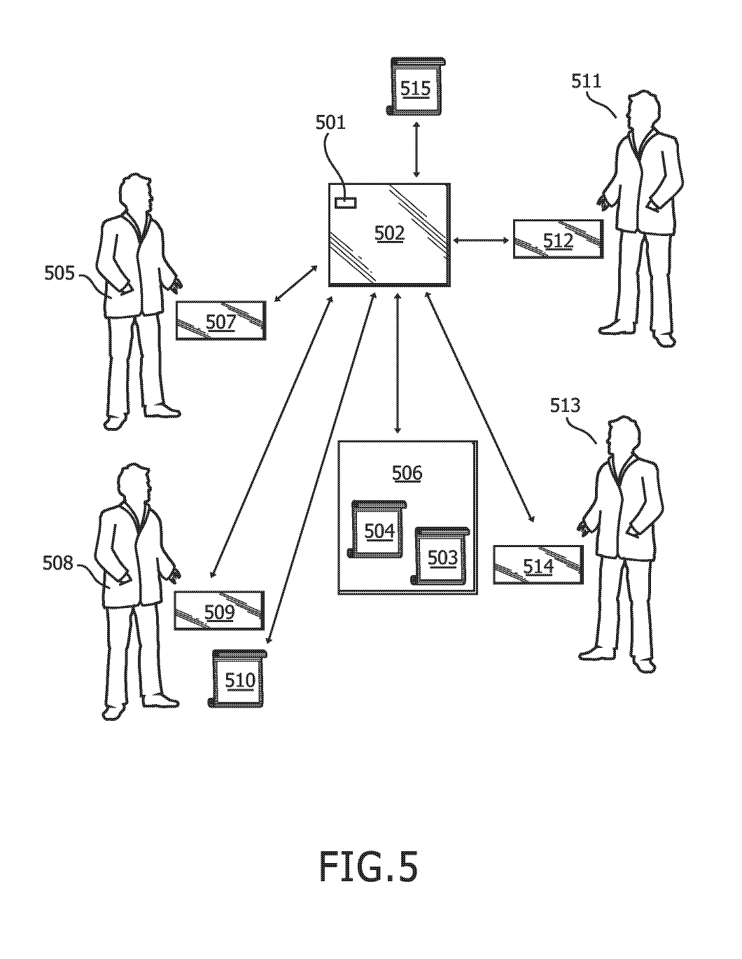

FIG. 5 shows a system for inheritance of an encrypted digital content item in accordance with still another embodiment of the invention.

With reference made to FIG. 1, which shows an embodiment of the present invention, if a user wishes to trigger a process of deleting or publishing his personal encrypted content item(s) posthumously, evidence such as a death certificate 101 should be presented to his device 102, on which the content item is stored. The death certificate of the user 103, i.e. the testator, may be obtained at a municipality or some other appropriate authority. The device can consequently publish or delete the content item. This is typically a process undertaken by a microprocessor 120. The user can ensure that no operations will be performed on the content items until a death certificate is presented to his device by organizing inheritance using his device (or possibly a TTP). An inheritance license 104—i.e. a testament—of the user is stored (step 1) on the device 102 (or at a TTP). This inheritance license specifies operations that are allowed to be performed on the encrypted content item after the death of its proprietor, in this particular embodiment deletion or publication of the content items. When an inheritor 105 requests (step 2) transfer of ownership of the content items from the device 102 of the testator 103 (or from a TTP on which the content items alternatively have been stored by the testator) to the inheritor's compliant device 106, the device 102 of the testator requires a certified proof 101 of death for the testator 103. This certificate will actually trigger the process of deletion/publishing. It should be noted that the above described operations specified in the inheritance license further may indicate the intended inheritor(s) of the encrypted content item.

At the moment the device accesses (step 3) the death certificate, it will enforce deletion/publication (step 4) of all content items with which the inheritance license is associated. Hence, the compliant device is authorized to perform the operations specified in the inheritance license 104 on the encrypted content item. In case publication of the encrypted content item is to be performed, it is, as previously described, necessary to include a content item decryption key in the inheritance license. Hence, the compliant device 102 is able to perform decryption to provide a clear text copy of the content item.

In another embodiment, which is illustrated in FIG. 2, an inheritance license, which specifies an owner's testament, comprises an identifier of an inheritor, for instance in the form of a public key. As mentioned hereinabove, the license should specify conditions on the process of inheritance. For example, the owner (testator) of the content item may specify the conditions of his final will, so that an inheritor can make the transfer of the ownership of the content item based on the license and a death certificate of the owner. These conditions are defined by means of the operations specified in the inheritance license, and associated with these conditions may also be information such as pointers to a device holding the inheritance license and the encrypted content item.

With reference to FIG. 2, the owner 203 of a content item to be inherited specifies his final will with an inheritance license 204, possibly without letting potential inheritors know that they are about to inherit something. In the inheritance license associated with an encrypted content item, the owner specifies an identifier of the inheritor 205 and possibly some conditions with respect to the inheritance process. For instance, the conditions may specify operations that are allowed on the content item, such as “play”, copy, “distribute” etc., but may also specify that transfer of ownership only is allowed if e.g. the inheritor has turned eighteen. The owner may further specify information pertaining to how the inheritors can be contacted after his death (inheritor's device URL, IP address, etc.).

To provide non-repudiation and integrity, the license is possibly signed by the owner. The license is stored (step 1) on the owner's compliant device 202, which comprises a microprocessor 220. Alternatively, the owner can copy the inheritance license and deposit it with a TTP (not shown). After the death of the testator, his device (or a TTP, if he has sent a copy of the inheritance license to the TTP) could prompt (step 2) the inheritors to initiate the transfer of ownership of the encrypted content item. The inheritor requests transfer of the ownership and presents (step 3) the death certificate 201 to the compliant device 202. The testator's device (or the TTP) will effect the transfer (step 4) of ownership in accordance with the inheritance license 204, which specifies inheritance information. In an exemplifying embodiment of the present invention, which also is illustrated in FIG. 2, a new ownership license 207 is created and sent to the inheritor (step 4). The new ownership license is typically arranged such that it includes operations that are allowed on the encrypted content item and possibly an identifier (e.g. a public key) of a new intended inheritor.

This new ownership license 207 specifies the inheritor as a new owner. After the transfer, the testator's device may delete the inheritance license, since the inheritance process has been completed. It should be noted that transfer of data in steps 3 and 4 may be made directly between the inheritor 205 and the compliant device 202 (or the TTP). In FIG. 2, steps 3 and 4 are undertaken via compliant device 206 which will create the new ownership certificate for the inheritor (based on the inheritance certificate created in step 1 and the death certificate of the inheritor). After creating the new ownership license, compliant device 206 could prompt compliant device 202 to delete the original inheritance license 204. It is also obvious to a skilled person that device 202 and 206 could be the same device.

In the example illustrated with FIG. 2, it is assumed that the new ownership license 207, which may be created based on the inheritance license 204 is stored in a centralized manner, so that there does not exist multiple copies of the ownership license with different inheritance information. However, in a system where licenses are allowed to be copied and freely distributed (and where a testator may change his mind with respect to inheritance), a timestamp could be included in the respective ownership license. Further, the system may implement synchronization and copy control of ownership licenses. For example, every time an ownership license copy is made and inheritance information is modified, the system could update a centrally stored ownership license. Inheritance will be allowed based on this centrally stored license. An ownership license typically specifies, like the inheritance license, operations that are allowed to be performed on the content item after the death of its current proprietor and further provides an identity of a new intended inheritor of said encrypted content item, generally in the form of a public key of the new intended inheritor.

With reference to FIG. 3, for a certain type of content item, for which it is immediately clear who the inheritor(s) should be (e.g. a family home video), the owner might want to regulate the inheritance directly and provide the inheritors with appropriate licenses. The testator 303 thus specifies his final will with respect to a content item when sharing this content item with an inheritor. He creates a usage license 308 for the inheritor, possibly giving him rights to access the content item, and specifies in the usage license that his final will is that the intended inheritor inherits the content item after his death. Hence, as shown in FIG. 3, the testator transfers the encrypted content item and the usage license from his compliant device 302 (comprising a microprocessor 320) to the inheritor (step 1), who can access the content item on his compliant device 306 according to the rights specified in the usage license until the death of the testator. After the testator's death, the inheritor can obtain an ownership certificate 309 (as has been described hereinabove) from his compliant device (or a TTP) for the content item (step 3) based on the usage license that specifies the final will of the testator and a death certificate 301 (step 2). This gives the intended inheritor unlimited rights with respect to the content item.

The approach of employing a usage license as described in connection to FIG. 3 is not appropriate for a content item for which the owner might change his mind with respect to inheritance. In this case, the approach based on ownership licenses is preferred. If an owner of a content item creates a usage license with his final will, sends it to an intended inheritor but later on changes his mind, he should be able to revoke that usage license. However, for some content items, the testator/owner may consider it acceptable that the content item is inherited by more than one inheritor. In that case, revocation of the usage license may not be necessary. If the testator/owner does not consider it acceptable that more than one inheritor inherits a content item, the owner's system must store information about his final will (i.e. who will inherit the content, what are the conditions to be satisfied, etc.) in the ownership license 307 associated with the content item. Each time a user wants to create a usage license for a content item, the system typically checks if the user is the owner of the content item (by inspecting the ownership license) and only if he is the owner, he is allowed to create a usage license and share the content item. If the owner wants to include information about the inheritance of the content item in the usage license, the system checks centralized inheritance information stored in the ownership license 307 and acts in accordance with this information. Therefore, creation of inconsistent testaments is prevented. Alternatively, the owner can specify, in the usage license, who the intended inheritor should be, but also that this is not his final will. In that case, the inheritor has to check with a TTP or the owner's device what the final will of the owner is. Only if the final will is in accordance with the will in the usage license, the inheritor can obtain the ownership license for the content item. The final will could be specified in an inheritance license (not shown).

In yet another embodiment of the present invention shown in FIG. 4, the way of specifying the intended inheritor and conditions for the inheritance process is to attach an additional license to the original inheritance license (not shown). This is necessary, if the original inheritance license is signed by a third party (e.g. a content provider in case a commercial content item used in a DRM system is to be inherited, or a certificate authority in case of inheritance of a personal content item). In this case, the testator cannot change the original usage license 408 and add inheritance information. However, he can append, i.e. associate, an additional license 409 to the original usage license (step 1), which will specify inheritance information (the inheritor identifier and conditions for inheritance/operations to be performed on the content item). The testator 403 can issue, via his compliant device 402 (comprising a microprocessor 420) licenses 408 and 409 to an inheritor 405 (step 2) if this is his final will, or he can keep the usage licenses (or deposit them with a TTP) and arrange such that ownership is transferred to the inheritor after the death of the testator. After the death of the testator, the two licenses 408, 409 and a death certificate 401 of the testator (step 3) will allow the inheritor to obtain (step 4), at his compliant device 406, a usage license 410 from a content provider 411.

Another exemplifying embodiment of the invention, which is shown in FIG. 5, illustrates a system having a cryptographic processor 501 arranged in a compliant device 502, with which a content item 503 is encrypted or decrypted using the content item encryption/decryption key (which is referred to as an asset key). The asset key is stored in an inheritance license 504 which typically specifies access rights for an intended inheritor 511 of the encrypted content item. The inheritance license is protected using asymmetric key-pair cryptography. In other words, the license 504 is encrypted with a public key of the intended inheritor 511, such that only the intended inheritor can decrypt the license with his private key using a rights-processor 512, and access the content item. The license and the content item are held in a storage 506 of the compliant device 502.

Appropriate usage of private keys by rights processors in the system enables secure authentication. The rights processor 507 of the testator 505 is required to conceal the testator's private key from being observed by any other entity, including himself. The inheritance license 504 is typically signed by a testator 505 of the encrypted content item 503. Typically, software in the form of a testament agent program running on the compliant device 502 is employed, which helps the testator 505, the executor 508 and the intended inheritor 511 to prepare, execute and complete the inheritance process, i.e. the transaction of the encrypted content item. When the testator wants to create his inheritance license, the agent program uses his rights processor 507 and his private key to create it.

As shown in FIG. 5, a testator 505 can prepare or modify his inheritance license using his private key, the rights processor 507 and the home compliant device 502. Because the inheritance license 504 is encrypted, it can be stored anywhere. The testator can choose a trusted executor, who can be one or several persons, or just the home compliant device 502. In FIG. 5, the trusted executor is denoted by 508. The executor can open the inheritance license posthumously with his rights processor 509 by using his private key and a death certificate 510 of the testator provided by a trusted authority. When the inheritance license 504 is in the clear, an intended inheritor 511 will receive rights with which her rights processor 512 can complete the transferring of ownership and/or usage rights of the encrypted digital content item 503. Then, the intended inheritor is the new owner of the content item. Note that the private key and the rights processor of the respective user in the system may be comprised in a small, tamperproof device, for example a smart card. The rights-processor could also be located in the compliant device, if it has a secure communication to the tamperproof device that contains the private key of the concerned user. It should be noted that in this exemplifying embodiment, it is the trusted executor (e.g. a lawyer or a family member) who is the one that can start the execution of the inheritance. Before the trusted executor starts the execution using the death certificate, no one can read the details of the inheritance license, which is important for the testator's privacy.

The inheritance license may in exemplifying embodiments of the present invention use attached digital containers that contain special rights transferring licenses or messages of each encrypted content item 503 for an intended inheritor 511. An example of a container is presented in (1). Using a container, the testator 505 can associate extra conditions to open the container, as shown in (3). For instance, a condition that may have to be complied with is that the intended inheritor is older than 18. The testator can establish one or more containers for an intended inheritor. Each container is encrypted with a container key, and the container key is stored in two container access messages (AMs), one for the testator 505 and one for the executor 508. The testator needs his AM to check and modify the container and the AM for the executor. The executor needs his AM to open the container posthumously and to deliver rights-transferring licenses or messages to the intended inheritor.

The AM for the executor is presented in (2). A first public key PubK_{executor} of the executor states that the executor is the user of the AM, and a second public key PubKₜₑₛₜₐₜₒᵣ of the testator states that the testator is the owner of the AM. The AM has two identical rights blocks: one is encrypted with PubK_{executor} and the other is encrypted with PubKₜₑₛₜₐₜₒᵣ. The details of the rights block is shown in (3), which include the container ID and key, usage rights and associated conditions. The AM is signed using the private key PKₜₑₛₜₐₜₒᵣ of the testator, so that the integrity of the AM can be verified using the public key of the testator. The testator can check the AM and the conditions inside, using his private key. The rights processor 509 of the executor can decrypt and read the executor's rights block using the executor's private key: First, the conditions to open the container are checked. Then, after the processor has received proper certificates of meeting the conditions, the processor will return the container key to the compliant device 502 to decrypt the container.

Container={E_{containerK}└{Licences_{Rights-transferring}}, {Rights−messages_{ownership-transferring}}┘} (1)

AM_{executor}={PubK_{executor},PubKₜₑₛₜₐₜₒᵣ,E_{PubK}_{_{executor}}[RightsB], E_{PubK}_{ₜₑₛₜₐₜₒᵣ}[RightsB]}Sign_{PK}_{ₜₑₛₜₐₜₒᵣ} (2)

RightsB={ContainerID,Rights=Open|_{conditions},ContainerK} (3)

The AM for the testator is presented in (4), in which the testator 505 is both the owner and the user of this message. Its rights blocks contain owner rights, as presented in (5). Using this owner rights-message, the testator can modify the container and the AM for the executor.

AM_{Testator}={PubKₜₑₛₜₐₜₒᵣ,PubKₜₑₛₜₐₜₒᵣ, E_{PubK}_{ₜₑₛₜₐₜₒᵣ}[RightsB], E_{PubK}_{ₜₑₛₜₐₜₒᵣ}[RightsB]}Sign_{PK}_{ₜₑₛₜₐₜₒᵣ} (4)

RightsB={ContainerID, Rights=Owner, ContainerK} (5)

Note that it is possible to combine equations (4) and (5) to create an access message.

The inheritance license may in embodiment of the invention, as shown in (6), contain a header, a list of control blocks for each container, and all the containers. The header, as shown in (7), has information pertaining to the testator, the executor, and the date of the last modification of the inheritance license. As shown in (8), the control block of a container comprises the container ID, the container access message AMₜₑₛₜₐₜₒᵣ for the testator and the container access message AM_{executor} for the executor, and information about the encrypted content item and intended inheritor in the container. The testator can use this information to announce content item assignment to the inheritor or legal authorities (e.g. a local tax office), which are in the noti field. The control block list is encrypted with the inheritance license key TestamentK, which has as an effect that the blocks are not accessible to the intended inheritor and the executor, before the inheritance license is posthumously open. The inheritance license contains a signature of the header and the encrypted control block information, which is made by the private key of the testator. Based on the signature, the integrity of the information in the inheritance license can be checked using the public key of the testator.

Inh.lic.={{Header,E_{TestamentK}[List(CtrlBs_{container})]}Sign_{PK}_{_{Testator}},{Containers}} (6)

Header={TestamentID, PubK_{Testator}, PubK_{Executor}, Date_{LastModification}} (7)

CrtlB={containerID,AM_{Testator},AM_{Executor},List[item(ID,PubKᵢₙₕₑᵣᵢₜₒᵣ,abstr,noti)]} (8)

The inheritance license key TestamentK is stored in two testament access messages, one for the executor and the other for the testator, with the same format of the container access messages as in (2) and (4).

The inheritance license AM for the executor states that the testator is the owner of the testament, and the executor is the user. Its rights block contains the right of posthumous opening for the executor, which requires the death certificate of the testator, as shown in (9).

RightsB_{executor}={TestamentID,Rights=Open|_{death(testator)},TestamentK} (9)

RightsBₜₑₛₜₐₜₒᵣ={TestamentID, Rights=Owner, TestamentK} (10)

The inheritance license AM for the testator states that the testator is both the owner and the user of the testament. Its rights block contains the owner rights as shown in (10). Because the testator is the owner, he can open the testament whenever he wants to check or change it.

A testator could also choose to have a multi-person executor (e.g. some or all of the family members). In this way, he makes sure that all executors gather to open the testament. To support this, the presented method is adjusted to support secret sharing. Thus, the testator splits the testament key TestamentK into different shares. Therefore, instead of storing the whole TestamentK, only a share of the key is stored in the license inheritance AM (9) for one person (executor). Consequently, the PubK_{executor} fields in (7) will contain a set of public keys of the executors. Therefore, the inheritance license can only be reconstructed when the shares are combined (individual shares are of no use on their own). Analogously, if the testator chooses a multi-person executor for a container in his inheritance license, the field of the ContainerK in (3) will store a share of the ContainerK (instead of the complete key) in the AM for one person (executor), and the AM_{executor} field in (8) will contain a set of container AMs for all the openers.

When the testator is dead, the testament agent program running on the compliant device 502 is employed by the executor 508 to complete the inheritance. The rights processor 509, using the private key of the executor, can decrypt the inheritance license access message to get the testament key, if it receives the death certificate of the testator. The content cryptographic processor 501 uses this testament key to decrypt the container control blocks. The information about the container, encrypted content item, the inheritor and conditions is open for the executor and the inheritor. When the executor 508 sends licenses/certificates for meeting the conditions of a container to his rights processor 509, the rights processor will deliver the container key to the content cryptographic processor 501 to decrypt the container. Note that the data integrity of the inheritance license 504 and the AM is checked based on signatures before they are decrypted.

All rights-transferring messages are then delivered to the inheritor 511. The rights processor 512 with the private key of the inheritor can use the received rights-transferring message to complete the inheritance. If the testator so requires (or if enforced by law), the agent can generate and sign a list of inherited content items during the transferring of the rights. The agent then sends this list to an authority as evidence of the inheritance. Advantageously, the intended inheritor can, after the transfer of ownership of the encrypted content item is completed, provide a message (not shown) with a digital signature to indicate that he has received and accepted the content item. This is important if there is e.g. a legal or tax issue involved in the inheritance.

As has been described in embodiments of the present invention hereinabove, when a compliant device or testament agent receives the death certificate of the testator, the executor of the testament can open the inheritance license, and then the intended inheritors can perform operations specified therein or use transfer-ownership messages, ownership licenses or some of the other licenses described to complete the inheritance process. Possibly a non-repudiable evidence that the inheritor has received and accepted the encrypted content item is provided. However, if an intended inheritor is dead before the process of inheritance is completed, or if he is not willing to accept the inheritance, the ownership of an encrypted content item cannot be transferred to him, even if other members of the testator's family could and are willing to inherit the content item.

In a further embodiment of the present invention, a queue of inheritors is introduced in the inheritance license 504, so that the ownership of an encrypted content item 503 still can be transferred to an inheritor 514, if a previously mentioned inheritor 511 in the inheritance licenses can/will not accept the content item. For example, in the inheritance license, a list of intended inheritors 511, 514 is specified, as well as operations that the respective intended inheritor is allowed to perform on the encrypted content item. The content item to be inherited is typically provided in one single (encrypted) copy, and a separate inheritance license is provided for each intended inheritor. The content item is encrypted with the asset key, and each inheritor has access to his own rights block (which contains the asset key) in the rights transferring license or message encrypted with his public key. An alternative solution is that each inheritor has his own container, which contains his particular rights transferring license.

For example, assume that there are two intended inheritors 511, 514 listed in the inheritance license 504. A right of a first inheritor 511 may for instance be to acquire ownership of the encrypted content item 503 associated with the license. A right of a second inheritor 514 may be to acquire the ownership on condition that the first inheritor refuses the content item, or that the first inheritor is deceased.

If the first inheritor 511 refuses the encrypted content item, a trusted compliant device 502 will generate a certificate 515 signed with a private key of the first inheritor, which certificate states he has refused the content item. The second inheritor 514 may use his private key to decrypt the rights transferring license 504, which previously has been encrypted with the public key of the second inheritor, if the trusted device 502 receives the certificate (of death in case of the first inheritor has deceased or of refusal 515 in case the first inheritor does not accept the content item) of the first inheritor. Then, the second inheritor is allowed to acquire the ownership of the content item. If neither the first 511 nor the second inheritor 514 can/will accept the encrypted content item 503, the trusted device 502 (which has its public key listed in the inheritance license) may create a clear text copy of the encrypted content item and publish it, if the testator 505 states so in the inheritance license.

The idea of enabling inheritance by multiple inheritors may be combined with the idea of introducing a queue of inheritors in the inheritance license. For example, if a man wants his wife to inherit a content item, but she is not able to do so, he may want his children to inherit it. Hence, instead of having a straight queue, the inheritance license may defined a queue in the form of a tree structure.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. A method of enabling inheritance of a digital content item, comprising:
acquiring an inheritance license for an encrypted digital content item, the inheritance license having operations that are allowed to be performed on the content item after the death of its proprietor; and
accessing a death certificate of the proprietor of said encrypted content item, wherein authorization is given to perform at least a subset of the operations, specified in the inheritance license, on the encrypted content item.

2. The method according to claim 1, wherein the inheritance license comprises a content item decryption key.

3. The method according to claim 1, wherein the inheritance license specifies that the content item should be deleted, said method further effecting deletion of the content item.

4. The method according to claim 1, wherein the inheritance license specifies that the content item should be published, said method further comprising decrypting the encrypted content item such that a clear text copy of said content item is provided and made public.

5. The method according to claim 1, wherein the inheritance license includes an identity of an intended inheritor of said encrypted content item, and said operations that are allowed to be performed on the content item after the death of its proprietor comprise establishing transfer of ownership to said intended inheritor, said method further comprising:
checking whether a matching criteria is satisfied for an identity of a claimant for said encrypted content item and the identity provided by the inheritance license; and
distributing, in case the matching criteria is considered to be satisfied, a content item decryption key to the claimant, wherein said claimant is given access to the content item.

6. The method according to claim 5, wherein said operations that are allowed to be performed on the content item after the death of its proprietor are defined by which access rights an intended inheritor has to said encrypted content item.

7. The method according to claim 5, wherein said identity of an intended inheritor of the content item is provided by including a public key of the intended inheritor in the inheritance license, and the matching criteria is considered to be satisfied if a public key of the claimant is identical to the public key included in the license.

8. The method according to claim 5, further comprising encrypting the content item decryption key with the public key of the intended inheritor before distribution.

9. The method according to claim 5 further comprising encrypting the inheritance license with a public key of the intended inheritor, wherein said identity of an intended inheritor of the content item is provided by the encryption of the inheritance license, and the matching criteria is considered to be satisfied if a successful decryption of the inheritance license is made with a private key that corresponds to the public key of the claimant.

10. The method according to claim 9, wherein decryption of the encrypted inheritance license is made after a trusted executor has accessed the death certificate of the proprietor.

11. The method according to claim 10, wherein further conditions must be satisfied before decryption is allowed, including that the intended inheritor must be 18 years or older.

12. The method according to claim 5, further comprising issuing an ownership license to the claimant for the content item in case the matching criteria is satisfied, the ownership license specifying the claimant as a new proprietor of the encrypted content item.

13. The method according to claim 12, further comprising including, in the ownership license, a timestamp representing time of issuing of said ownership license.

14. The method according to 12, wherein the ownership license specifies operations that are allowed to be performed on the content item after the death of its current proprietor and the ownership license further provides an identity of a new intended inheritor of said encrypted content item.

15. The method according to claim 5, further comprising
signing the inheritance license at a trusted third party;
creating an additional license which specifies operations that are allowed to be performed on the content item after the death of its proprietor, wherein the additional license further provides an identity of the intended inheritor of said encrypted content item; and
associating said additional license with the inheritance license.

16. The method according to claim 5, further comprising signing a message at the intended inheritor after transfer of ownership of the encrypted content item has been completed.

17. The method according to claim 5, further comprising including, in the inheritance license, a list of intended inheritors and operations that each intended inheritor is allowed to perform on the encrypted content item, wherein ownership of the encrypted content item can be transferred to a second inheritor if a first inheritor is deceased or does not accept the content item.

18. The method according to claim 1, further comprising generating a certificate signed with a private key of the first inheritor, wherein the certificate is used to determine whether ownership may be transferred to the second inheritor, in case the first inheritor does not accept the content item.

19. The method according to claim 17, wherein a death certificate of the first inheritor is used to determine whether ownership may be transferred to the second inheritor in case the first inheritor is deceased.

20. The method according to claim 17, wherein ownership of the encrypted content item can be transferred to at least a second and a third inheritor if a first inheritor is deceased or does not accept the content item.

21. The method according to claim 1, further comprising signing the inheritance license with a private key of a current proprietor of said content item.

22. A device for enabling inheritance of a digital content item, comprising:
means for acquiring an inheritance license for an encrypted digital content item, wherein the inheritance license specifies operations that are allowed to be performed on the content item after the death of its proprietor, the means accessing a death certificate of the proprietor of said encrypted content item, and wherein authorization is given to perform at least a subset of the operations specified in the inheritance license on the encrypted content item.

23. The device according to claim 22, wherein the inheritance license comprises a content item decryption key.

24. The device (102) according to claim 22, wherein the inheritance license specifies that the content item should be deleted and the means is arranged to delete the content item.

25. The device (102) according to claim 22, wherein the inheritance license specifies that the content item should be published and the means is arranged to decrypt the encrypted content item such that a clear text copy of said content item is provided and made public.

26. The device according to claim 22, wherein the inheritance license provides an identity of an intended inheritor of said encrypted content item, and said operations that are allowed to be performed on the content item after the death of its proprietor comprise establishing transfer of ownership to said intended inheritor, and the means is arranged to check whether a matching criteria is satisfied for an identity of a claimant for said encrypted content item and the identity provided by the inheritance license and to distribute, in case the matching criteria is considered to be satisfied, a content item decryption key to the claimant, wherein said claimant is given access to the content item.

27. The device according to claim 26, wherein said operations that are allowed to be performed on the content item after the death of its proprietor are defined by which access rights an intended inheritor has to said encrypted content item,

28. The device according to claim 26, wherein said identity of an intended inheritor of the content item is provided by including a public key of the intended inheritor in the inheritance license, and the matching criteria is considered to be satisfied if a public key of the claimant is identical to the public key included in the license.

29. The device according to claim 26, wherein the means is arranged to encrypt the content item decryption key with the public key of the intended inheritor before distribution.

30. The device according to claim 26, wherein the means is arranged to encrypt the inheritance license with a public key of the intended inheritor, wherein said identity of an intended inheritor of the content item is provided by encrypting the inheritance license, and the matching criteria is considered to be satisfied if a successful decryption of the inheritance license is made with a private key that corresponds to the public key of the claimant.

31. (canceled)

32. (canceled)

33. (canceled)

34. The device (302) according to claim 26, wherein the means is arranged to issue an ownership license to the claimant for the content item in case the matching criteria is satisfied, wherein the ownership license specifies the claimant as a new proprietor of the encrypted content item.

35. The device according to claim 34, wherein the ownership license includes a timestamp representing time of issuing of said ownership license.

36. The device (302) according to claim 34, wherein the ownership license specifies operations that are allowed to be performed on the content item after the death of its current proprietor and the ownership license further provides an identity of a new intended inheritor of said encrypted content item.

37. The device (402) according to claim 26, wherein the means is arranged to create an additional license which specifies operations that are allowed to be performed on the content item after the death of its proprietor, wherein the additional license further provides an identity of the intended inheritor of said encrypted content item and arranged to associate said additional license with the inheritance license.

38. The device (502) according to claim 26, wherein the inheritance license is arranged to specify a list of intended inheritors and operations that each intended inheritor is allowed to perform on the encrypted content item, wherein the ownership of the encrypted content item can be transferred to a second inheritor if a first inheritor is deceased or does not accept the content item.

39. The device according to claim 38, further comprising a certificate signed with a private key of the first inheritor, wherein the certificate is used to determine whether ownership may be transferred to the second inheritor in case the first inheritor does not accept the content item.

40. The device according to claim 38, wherein a death certificate of the first inheritor is accessed to determine whether ownership may be transferred to the second inheritor in case the first inheritor is deceased.

41. The device (502) according to claim 38, wherein the ownership of the encrypted content item is transferred to at least a second and a third inheritor if a first inheritor is deceased or does not accept the content item.

42. The device (502) according to claim 26, wherein the inheritance license is signed with a private key of a current proprietor of said content item.
